(19) United States
(12) Patent Application Publication
(10) Pub. No.: US 2018/0310768 A1
(43) Pub. Date: Nov. 1, 2018

(54) DEVICE FOR MINIMIZING MOISTURE LOSS FROM MEAT CAUSED BY PIERCING

(71) Applicant: Dermot B. EARLEY, Yonkers, NY (US)

(72) Inventor: Dermot B. EARLEY, Yonkers, NY (US)

(21) Appl. No.: 15/946,305

(22) Filed: Apr. 5, 2018

Related U.S. Application Data
(60) Provisional application No. 62/469,732, filed on Mar. 10, 2017.

(51) Int. Cl. A47J 43/00; G01K 13/00

(52) U.S. Cl. CPC A47J 43/00; G01K 13/00

(57) ABSTRACT

A device that plugs a hole in meat being cooked, the hole of which has been formed by a meat thermometer. The device minimizes and or avoid the escape of liquefied fat or other natural secretions from the meat to promote overall tenderness (i.e., juiciness) of meat upon being cooked. The device consists of a stop that comprises a head portion having a surface area greater than the opening of a hole pierced in meat. The head has an upper surface and a lower surface. Extending from the lower surface is a shaft that has geometry similar to a shaft of a meat thermometer, however it is slightly larger in order to fill in the gap made by a thermometer. The upper surface of the head is shaped and sized so it may allow a user to easily remove the stop. In an embodiment, the upper surface includes a non-melting, low thermal conductivity element such as a piece of silicon rubber.

### CROSS-REFERENCE TO RELATED APPLICATIONS

This application claims the benefit of provisional patent application Ser. No. 62/469,732 filed Mar. 10, 2017.

### FIELD OF THE INVENTION

This application relates generally to the culinary field and thermometers, in particular, the instant invention is a device that is used in connection with a meat thermometer to stop and or reduce loss of moisture from meat when cooked.

### BACKGROUND OF THE INVENTION

During the cooking process of meat for example, it is well-known for a cook to use a thermometer to measure the temperature of the inside of the meat in order to regulate the cooking of the meat so a desired temperature of the product is realized. In practice, a meat thermometer pierces an outer surface of the meat, continuing a certain distance therein, whereby a temperature is gauged. After the temperature is read, the thermometer is removed leaving a hole, which now serves as a conduit for moisture, such as liquefied fat, to escape the meat. Due to this loss, the ultimate product has less moisture and tenderness than it would have had the liquid retained. Because moisture is directly related to quality and or flavor of a cooked product, there is a need in the industry for a device that reduces and or eliminates moisture loss caused from thermometer piercing.

### BRIEF DESCRIPTION OF THE DRAWINGS

The invention is explained in the following description in view of the drawings that show:

FIG. 1 is a perspective view of a typical meat thermometer.

FIG. 2 is a perspective view of a piece of meat having a meat thermometer inserted therein.

FIG. 3 is a sectional view of FIG. 2 taken along section A-A.

FIG. 4 is a perspective view of FIG. 2, after thermometer is removed, showing moisture escaping.

FIG. 5 is a sectional view of FIG. 4 taken along section B-B, showing moisture collecting within hole.

FIG. 6 is a perspective view of a device according to an embodiment of the instant invention.

FIG. 7 is a perspective view of a piece of meat from FIG. 4, prior to device of FIG. 6 being inserted thereto.

FIG. 8 is a perspective view of the piece of meat from FIG. 4 with device of FIG. 6 inserted thereto.

FIG. 9 is a sectional view of FIG. 8 taken along section C-C.

### DETAILED DESCRIPTION OF THE INVENTION

The instant invention is for a device that plugs a hole for example in meat being cooked, the hole of which being formed by a meat thermometer. The purpose of the device is to minimize and or avoid the escape of liquefied fat or other natural secretions from a cooking product to promote overall tenderness (i.e., juiciness) upon being cooked. An advantage of the instant device also acts as a locator for the pierced hole, avoiding the need to puncture something more than once in multiple locations.

The device consists of a stop that comprises a head portion having a surface area greater than the opening of a hole pierced in the meat for example. The head has an upper surface and a lower surface. Extending from the lower surface is a shaft that has geometry similar to a shaft of a thermometer; however, it is slightly larger in order to substantially fill at least a portion of the gap made by a thermometer. The upper surface of the head is shaped and sized so it may allow a user to easily remove the stop. In an embodiment, the upper surface includes a non-melting, low thermal conductivity element such as a piece of silicon rubber.

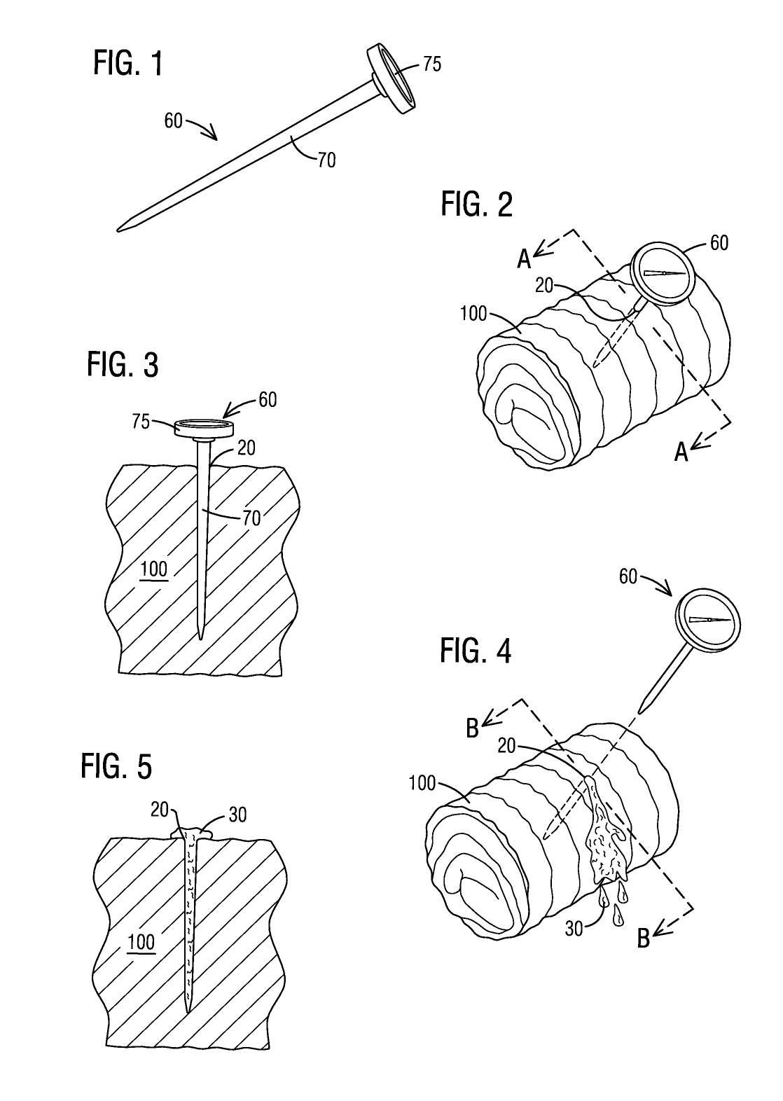

FIG. 1 shows an embodiment of a basic meat thermometer, 60. As shown, the meat thermometer may be described as having a shaft 70 and a gauge 75. The shaft typically has an elongated conical shape with a tip that is capable of piercing products such as meat. FIG. 2 shows the general application and or method of use of a thermometer 65 when used to measure the temperature inside a piece of meat 100. As shown, the tip of the thermometer 60 has pierced the outer surface of the meat 100 forming hole 20. The shaft of the thermometer extends within the meat and defines the internal depth of hole 20 and diameter.

FIG. 3 is a sectional view of FIG. 2 taken along section A-A. As shown, the shaft 75 of thermometer 60 defines hole 20 formed in the meat 100. FIG. 4 is a perspective view of FIG. 2, after the thermometer 60 is removed from meat 100. As shown, upon removing the thermometer 60, moisture 30 accumulates within and escapes from hole 20 causing the product to lose moisture.

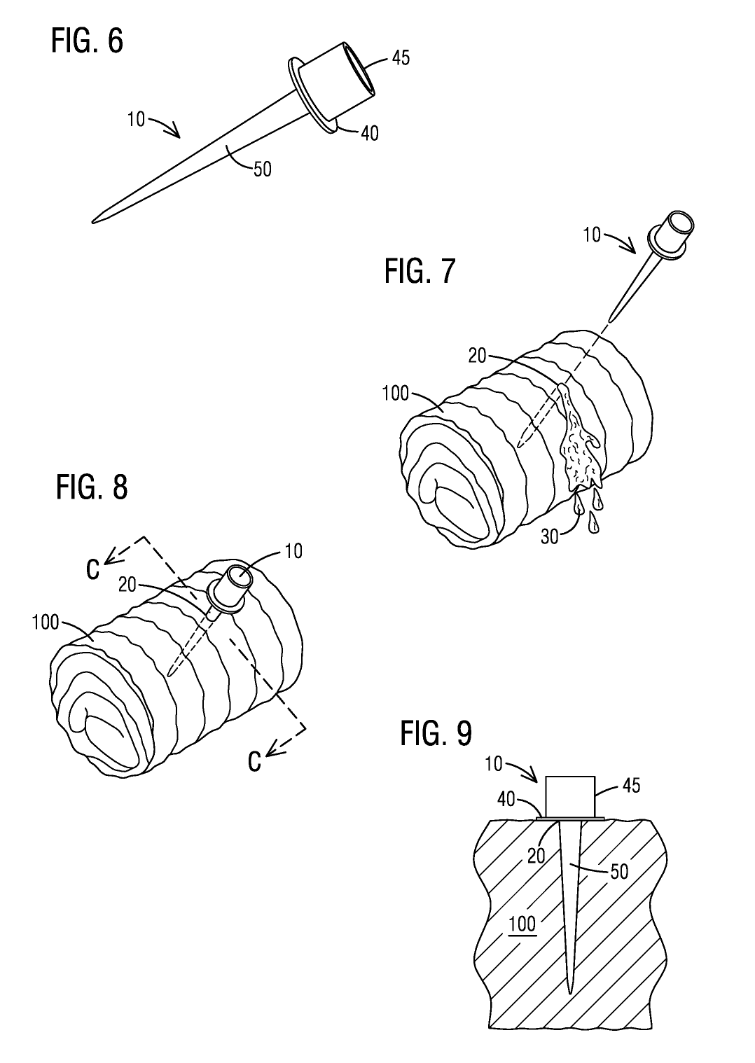

FIG. 5 is a sectional view of FIG. 4 taken along section B-B, showing moisture 30 collecting within hole 20. FIG. 6 is a perspective view of a device 10 according to an embodiment of the instant invention. As shown, the device 10 consists of a head 40 which may have an area and or diameter greater than opening of hole 20. Extending from a lower surface of head 40 is shaft 50 which has a geometry similar to shaft 70 of thermometer 60, however it is slightly thicker and or larger in order to better fill hole 20 and avoid escape of moisture. It is within the scope of the invention that the length of shaft 70 may be less than the length of the corresponding thermometer, whereby it is an object of the invention that a portion of shaft 50 has a diameter and or area greater than an internal area or diameter of hole 20 such that passage of moisture therefrom may be minimized or reduced.

In an embodiment, the upper surface of head 40 includes a non-melting, low thermal conductivity element such as a piece of silicon rubber 45. FIG. 7 is a perspective view of a piece of meat 100 having a hole 20 that has moisture 30 escaping and is just prior to device 10 being inserted thereto. FIG. 8 is a perspective view of the piece of meat from FIG. 4 with device 10 inserted within a portion of hole 20 such that moisture is no longer escaping from the meat.

FIG. 9 is a sectional view of FIG. 8 taken along section C-C showing how the device according to the instant invention avoids the escape of moisture from a piece of meat after being pierced by a meat thermometer. As shown in the embodiment, device 10 fills a substantial amount of the hole 20 and or void made by the thermometer. It is within the scope of the invention that shaft 50 extends just beyond the opening of hole 20 and has sufficient width and or diameter such that it prevents moisture from escaping therefrom.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A device for device for minimizing moisture loss from meat cause by a thermometer whereby said device comprises:
a head having an upper surface and a lower surface;
whereby the area of the lower surface is greater than the area of the opening of a hole formed on a piece of meat by a meat thermometer shaft;
a shaft extending from the lower surface of the head, exhibiting similar geometry as the meat thermometer shaft, but having greater dimensions in order to sufficiently fill a portion of the hole to impede moisture loss.
